(19) United States
(12) Patent Application Publication
(10) Pub. No.: US 2017/0210609 A1
(43) Pub. Date: Jul. 27, 2017

(54) BOTTLE FILLER, CAPPER AND CORKER SYSTEM AND METHOD

(71) Applicant: DK ADVANCED TECHNOLOGIES LLC, FORT EDWARD, NY (US)

(72) Inventors: CARL SCOTT LUFKIN, ARGYLE, NY (US); DANIEL THOMAS KOMARONY, GREENWICH, NY (US)

(21) Appl. No.: 15/418,259

(22) Filed: Jan. 27, 2017

Related U.S. Application Data
(60) Provisional application No. 62/288,634, filed on Jan. 29, 2016.
(60) Provisional application No. 62/287,751, filed on Jan. 27, 2016.

(51) Int. Cl. B67C 7/00; B67C 3/24; B67C 3/28; B67B 3/02; B67C 3/00; B67C 3/22; B67B 1/04

(52) U.S. Cl. CPC B67C 7/00; B67C 3/225; B67C 3/24; B67B 1/04; B67B 3/02; B67C 3/007; B67C 3/282

(57) ABSTRACT

Disclosed is a bottling system including a frame having a lane configured to receive a bottle tote holding a plurality of bottles, a filling station located above a first location along the lane, the filling station including a plurality of fill valves configured to simultaneously fill the plurality of bottles, a finishing station located above a second location along the lane, the finishing station including at least one cylinder, the at least one cylinder configured to plunge a plurality of plunging portions, each of the plurality of plunging portions configured to receive a crowing die. The system includes a corking mechanism attachable to the frame at the finishing station, the corking mechanism including a plurality of openings each configured to receive a cork, each of the plurality of plunging portions extending through one of the plurality of openings when plunged by the at least one cylinder.

### CROSS-REFERENCE TO RELATED APPLICATIONS

This application is a continuation application of claims priority from co-pending from provisional U.S. Patent Application No. 62/287,751, filed Jan. 27, 2016, entitled “Bottle Filler, Capper and/or Corker System and Method, and provisional U.S. Patent Application No. 62/288,634, filed Jan. 29, 2016, entitled “Bottle Filler, Capper and/or Corker System and Method, which are each hereby incorporated by reference in their entirety.

### TECHNICAL FIELD

The subject matter disclosed herein generally relates to a bottling system and method that includes capping and/or corking. More particularly, the subject matter includes a system and method that provides for easily and quickly switching between capping and corking.

### BACKGROUND

Systems exist for filling and capping or corking of bottles to contain any variety of juices, beers, wines, ciders or other carbonated or non-carbonated liquids. However, these systems are often expensive, and often require a great number of components and high degree of complexity. Due to these factors, these complex and costly systems are generally purchased by companies or individuals looking to fill a large number of bottles and are generally only cost effective when these machines are required to fill and bottle with minimal downtime. As such, smaller companies or individuals are forced to either fill bottles using slow and costly manual fill techniques, or outsource the filling and capping of their bottles to larger companies that do possess these expensive and complex filling, capping and/or corking machines. Further, existing filling and capping and/or corking systems are not modularly constructed in order to allow for strategic expansion. Existing filling and capping and/or corking systems further lack the ability to easily switch between capping and corking as needed.

Thus, an improved bottle filler, capper and corker system and method would be well received in the art.

### BRIEF DESCRIPTION

In accordance with one embodiment, a bottle filler, capper and corker system comprises: a frame including a lane configured to receive a bottle tote holding a plurality of bottles; a filling station located above a first location along the lane, the filling station including a plurality of fill valves configured to simultaneously fill the plurality of bottles; a finishing station located above a second location along the lane, the finishing station including at least one pneumatic cylinder, the at least one pneumatic cylinder configured to plunge a plurality of plunging portions, each of the plurality of plunging portions configured to removably receive a crowing die; and a corking mechanism removably attachable to the frame at the finishing station, the corking mechanism including a plurality of openings each configured to receive a cork, each of the plurality of plunging portions extending through one of the plurality of openings when plunged by the plurality of pneumatic cylinders.

In accordance with another embodiment, a method of filling, capping and corking bottles comprises: providing a bottle filler, capper and corker system including: a frame including a lane; a filling station located above a first location along the lane, the filling station including a plurality of valves; a finishing station located above a second location along the lane, the finishing station including at least one pneumatic cylinder, the at least one pneumatic cylinder configured to plunge a plurality of plunging portions; and filling, by the filling station through the plurality of valves, a first plurality of bottles; receiving, by each of the plurality of plunging portions, a separate crowning die; plunging, with the at least one pneumatic cylinder, the plurality of plunging portions; capping the first plurality of bottles with each of the separate crowing die; removing the separate crowing die from each of the plurality of plunging portions; filling, by the filling station through the plurality of valves, a second plurality of bottles; attaching a corking mechanism to the frame above the second location along the lane, the corking mechanism including a plurality of openings and a collapsing device located in each of the plurality of openings; receiving, in each of the plurality of openings, a separate cork; collapsing, with the collapsing device, each of the separate corks; plunging, with the at least one pneumatic cylinder, each of the plurality of plunging portions through one of the plurality of openings; and pushing, with each of the plurality of plunging portions, each of the separate corks into top openings in the second plurality of bottles.

In accordance with another embodiment, a corking mechanism comprises: a first vertical sliding guide slidably attachable to a first vertical post; a second vertical sliding guide slidably attachable to a second vertical post; a plurality of openings each configured to receive a cork; a collapsing device located in each of the plurality of openings; a spring; and a pneumatic cylinder system in the corking mechanism, wherein the pneumatic cylinder system is configured to collapse each of the collapsing devices located in each of the plurality of openings.

### BRIEF DESCRIPTION OF THE DRAWINGS

FIG. 1 depicts a perspective view of a bottle filler, capper and/or corker system in accordance with one embodiment;

FIG. 2 depicts a perspective view of a fill valve of the bottle filler, capper and/or corker system of FIG. 1 in accordance with one embodiment;

FIG. 3 depicts a cross sectional view of the fill valve of FIG. 2 in accordance with one embodiment;

FIG. 4 depicts a schematic view of an electrical system of the bottle filler, capper and/or corker apparatus of FIG. 1 in accordance with one embodiment; and

FIG. 5 depicts a schematic view of a pneumatic system of the bottle filler, capper and/or corker system of FIG. 1 in accordance with one embodiment.

FIG. 6 depicts a side view of the bottle filler, capper and/or corker system of FIG. 1 with crowing dies in place for capping in accordance with one embodiment;

FIG. 7 depicts a side view of the bottle filler, capper and/or corker system of FIGS. 1 and 6 with the crowing dies removed in accordance with one embodiment;

FIG. 8 depicts a side view of the bottle filler, capper and/or corker system of FIGS. 1 and 6-7 with cork pushers installed in accordance with one embodiment;

FIG. 9 depicts a side view of the bottle filler, capper and/or corker system of FIGS. 1 and 6-8 with a corking mechanism installed in accordance with one embodiment;

FIG. 10 depicts a perspective view of the corking mechanism of FIG. 9 in accordance with one embodiment;

FIG. 11 depicts a top view of the corking mechanism of FIGS. 9-10 with a top frame removed to expose two cork collapsing mechanisms in accordance with one embodiment;

FIG. 12 depicts an expanded view of one of the cork collapsing mechanisms of FIG. 11 in an open position in accordance with one embodiment; and

FIG. 13 depicts an expanded view of the cork collapsing mechanism of FIG. 12 in a closed position in accordance with one embodiment.

### DETAILED DESCRIPTION

A detailed description of the hereinafter described embodiments of the disclosed apparatus and method are presented herein by way of exemplification and not limitation with reference to the Figures.

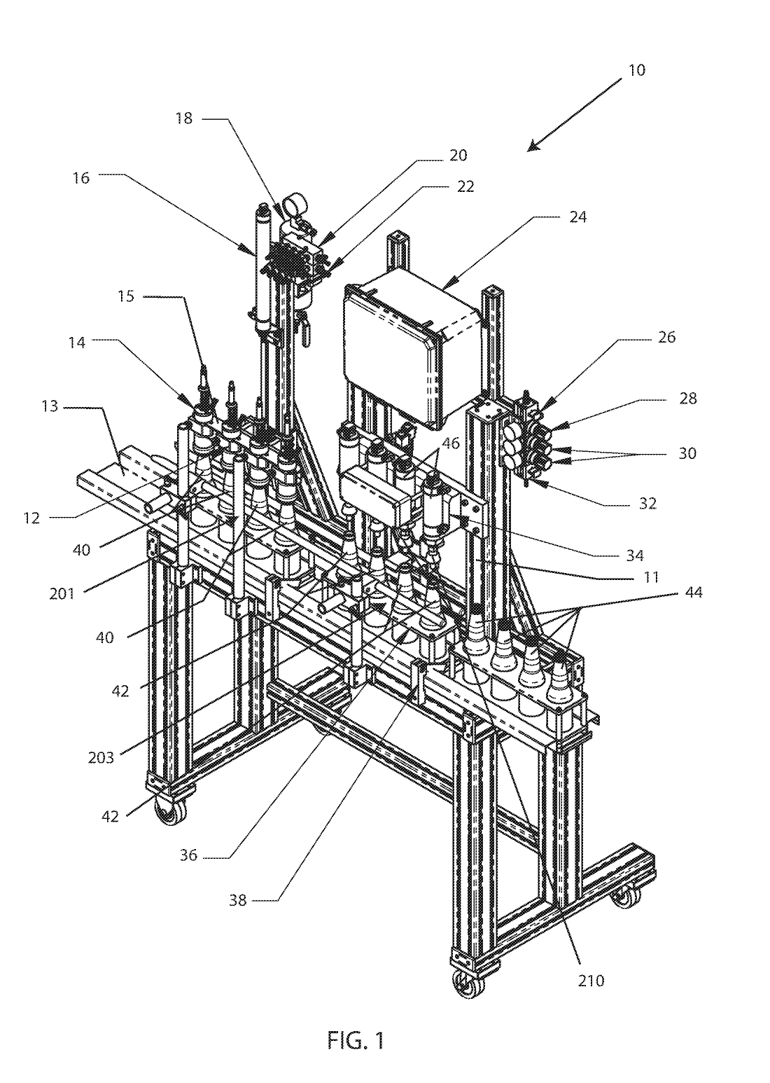

Referring first to FIG. 1, a perspective view of a bottle filler, capper and/or corker system 10 is shown. The bottle filler, capper and/or corker system 10 may include a filling station 12, a fill valve 14, a filling station cylinder 16, a vent can assembly 18, a vent manifold 20, and a fluid supply manifold 22, a control box 24, a compressed air inlet and shutoff 26, a compressed air regulator 28, a plurality of CO2 regulators 30, a CO2 inlet and shutoff 32, a capping and/or corking station 34, a bottle tote 36 and a tote stop 38. In the embodiment shown, four bottles 40 are shown at the filling station 12, four bottles 42 are shown at the capping and/or corking station 34, and four completed bottles 44 are shown after having been capped at the capping and/or corking station 34. The bottle filler, capper and/or corker system 10 may be configured to receive bottles 40, 42, 44 inline from left to right in an upright orientation. The bottles 40 are first filled with liquid at the filling station 12, then moved in line to the capping and/or corking station 34 to apply caps to the filled bottles, then finally moved to an unloading station for removal from the bottle filler, capper and/or corker system 10. The bottle filler, capper and/or corker system 10 may be modular in design to allow for expansion or even retraction of the stations 12, 34 relative to the embodiment shown in FIG. 1. The bottle filler, capper and/or corker system 10 may further allow for additional automation in a modular manner as the needs of the user expand. The bottle filler, capper and/or corker system 10 may quickly and easily be reconfigured to fill bottles of all sizes.

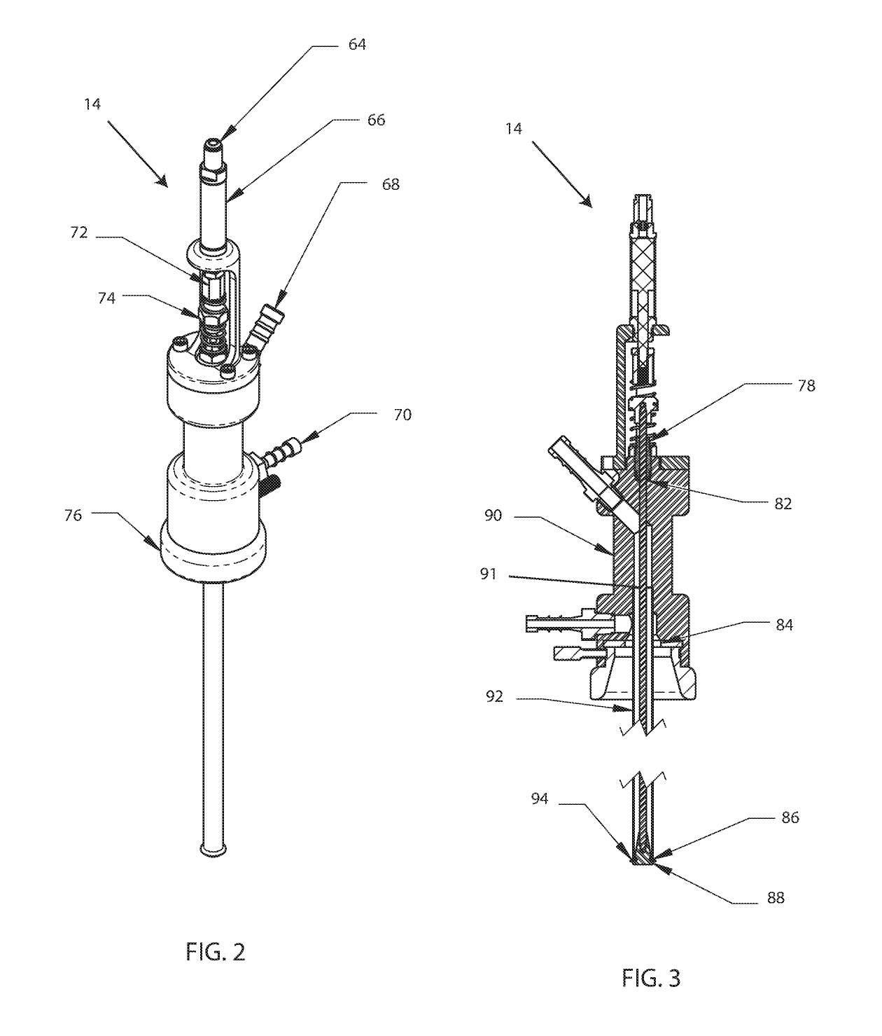

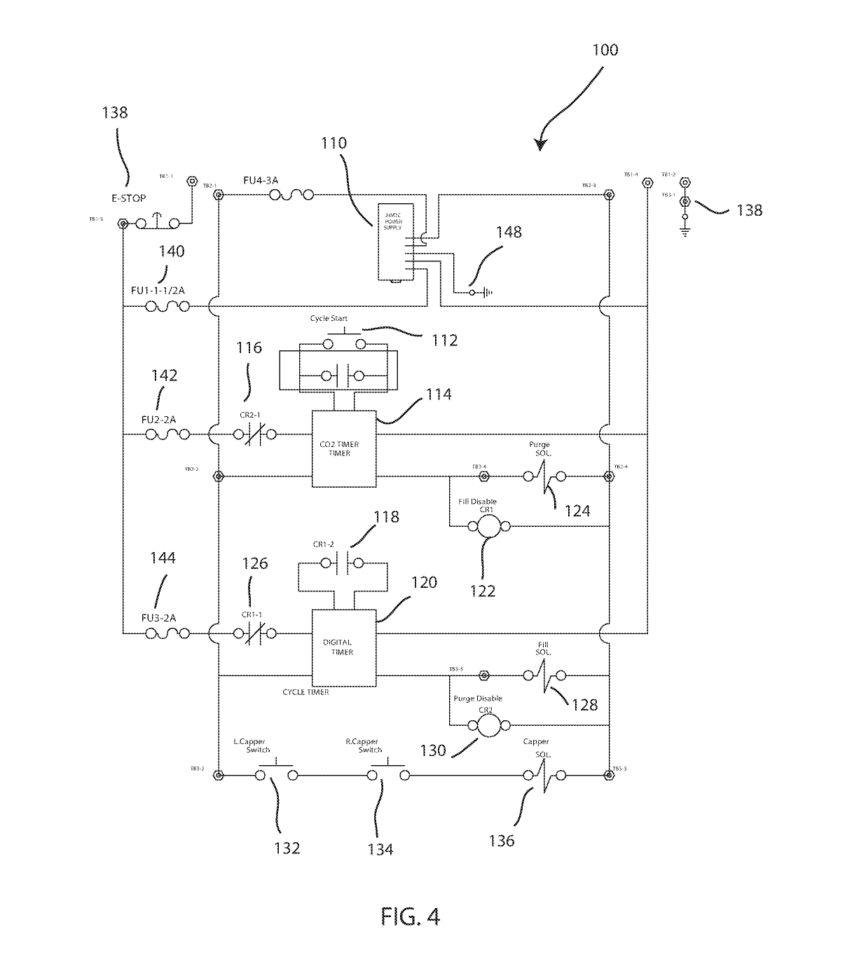

A first group of four bottles 40 may first be presented to the filling station 12 at a first location 201 where the filling valves 14 (shown more closely in FIG. 2-3) may be configured to descend into their respective bottle 40 and fill it with fluid. The first location 201 may be a location along the lane or channel 13 that is directly below the filling valves 14 and the filling station 12. The filling station 12 may be actuated by a cycle start switch 112 (described herein below and shown in FIG. 4) on the control box 24. This cycle start switch 112 may be configured to actuate movement of the filling station 12 downward onto the bottles 40 in a sealed manner. The fill cycle may then include both a purge cycle and a fill cycle for filling the bottles. The parameters of the purge and fill cycle (i.e. times) may be adjustable by an interface provided in the control box 24, for example, to provide for the filling larger and smaller bottles, and the filling of bottles at faster and slower speeds.

The bottle filler, capper and/or corker system 10 may further include the capping and/or corking station 34 for capping a second group of four bottles 42 once they have been filled at the filling station 12. The capping and/or corking station 34 may further be referred to as a finishing station and may be configured to apply either a cap or a cork or other top to a bottle or other container. The capping and/or corking station 34 may be located above a second location 203 along the lane or channel 13. The capping and/or corking station 34 may be actuated by the pressing of a button or activating a switch to press caps onto the bottles 42 through the activation of capping and/or corking station cylinders 46. The capping and/or corking station cylinders 46 may require an operator to simply place uncrimped caps onto each of the second group of four bottles 42 and then activate the capping and/or corking station 34. Once completed, the bottle filler, capper and/or corker system 10 may include space for receiving a third group of filled and capped bottles 44 that may be utilized by an operator for unloading the third group of filled and capped bottles 44 from the bottle filler, capper and/or corker system 10. While FIG. 1 shows that the capping and/or corking station 34 in a capping mode with crowing dies 35 attached on each of the capping and/or corking station cylinders 46, embodiments described herein below are contemplated where the capping and/or corking station 34 is convertible into a corking mode for corking bottles instead of applying caps.

FIGS. 2-3 show views of an exemplary fill valve 14 as shown in the bottle filler, capper and/or corker system 10. The fill valve 14 may include a fill tube 92 having a fluid stopper 88, a fluid stopper seal 86, and a sealing flare 94. The fill tube 92 may be configured to dispense the liquid at the bottom of the bottles 40, 42, 44 and may be configured to eliminate turbulence. The fill tube 92 may allow for the filling of carbonated beverages as well as non-carbonated beverages.

The fluid to be dispensed may be supplied to a liquid inlet 68 at a steady and controlled pressure. The liquid inlet 68 may interface with a supply tube, hose, or other conduit that attaches to the fluid supply, such as a keg or other fluid reservoir. A gland packing nut 78 may be provided that may be threaded into a valve body 90 far enough to apply sufficient pressure to push a gland 82 into the tapered hole in the valve body 90 so as to prevent pressurized fluid leakage around a stopper rod 91.

In operation, the valves 14 may be lowered into the bottle 40 by means of a switch 112 (described herein below and shown in FIG. 4) on the control box 24. As the valves 14 are lowered into the bottles 40, the valves 14 may be guided into place by a bottle alignment guide 76 such that the bottles 40 seal against a bottle gasket 84. Carbon dioxide may be supplied to a carbon dioxide in and vent out valve 70 for a controlled time. Carbon dioxide may be supplied by a supply tube, hose, or similar conduit that may be attached to the carbon dioxide in and vent out valve 70 for a predetermined period of time. After such time, the carbon dioxide in and vent out valve 70 switches functions and becomes an outlet for gas displaced from the bottle 40 as it fills with fluid. The outlet pressure on the carbon dioxide in and vent out valve 70 (i.e. counter pressure in the bottle 40) may be controlled by, for example, the vent can assembly 18. In this way, the carbon dioxide in and vent out valve 70 may act as an adjustable pressure relief valve having an adjustable pressure relief pressure set by an operator through an interface found in the control box 24. The control box 24 may include a processor, microprocessor, programmable logic controller or the like that is configured to control the filling station 12 and the finishing station 34.

Air pressure may be supplied to a pneumatic valve actuator 66 through an actuator airline connection 64 via a tube, hose, or similar conduit (not shown) connected to an air supply reservoir or tank. Air pressure supplied to the pneumatic valve actuator 66 may provide pressure to push an actuation adjusting nut 72 down to compress a spring 74 and in turn move the fluid stopper seal 86 and the fluid stopper 88 away from the sealing flare 94 to allow fluid to flow into the bottle 40. This may occur for a controlled time period after which the pneumatic valve actuator 66 then releases to stop the flow of fluid. If minor adjustments are needed to equalize flow rates on all valves on any particular machine, this is accomplished by adjusting the actuation adjusting nut 72 to allow more or less movement of the spring 74, the fluid stopper seal 86 and the fluid stopper 88 accordingly, thereby increasing or decreasing flow.

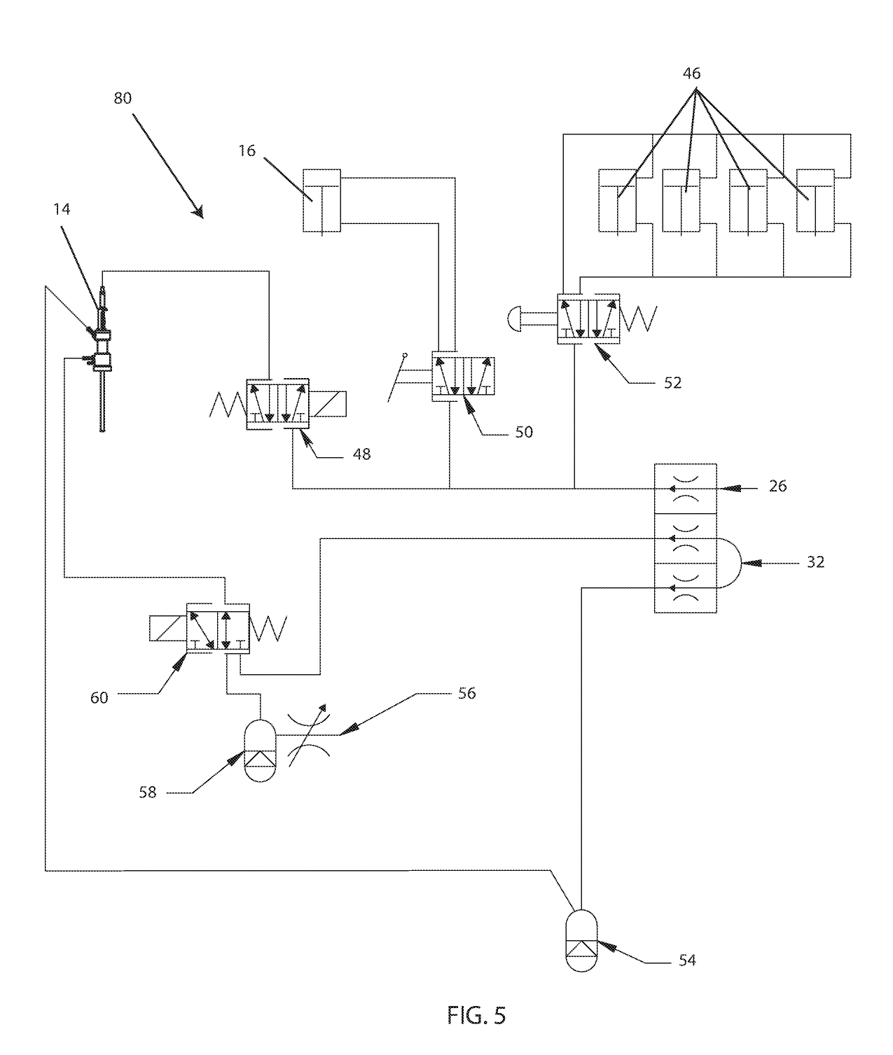

Referring now to FIG. 4, a schematic view of an electrical system 100 of the bottle filler, capper and/or corker system 10 is shown. The electrical system 200 may include a plurality of fuses 140, 142, 144, 145, a plurality of variable capacitors 116, 126, a plurality of switches 138, 112, 132, 134, a plurality of solenoids 124, 128, 136, a capacitor 118, timers 114, 120, contact relays 122, 130, and grounds 148, 146. This electrical system 100 may be configured to open and close the solenoid valves 48, 60 (described herein below and shown in FIG. 5) based on the input from the timer circuits 114, 120 which may be controlled through inputs provided by an operator interacting with the control box 24. The timer circuits 114, 120 may be set for various lengths of time so that when the cycle start switch 112 is activated by the operator, the solenoids 124, 128 are activated in accordance with the preset timer such that the solenoid valve 48 fills the bottles 40 with fluid in accordance with the timer so that the amount of fluid dispensed by the valves 48 may be predetermined and accurately fill the bottles 40 to the desired level. Similarly, the solenoid purge valve 60 may be activated as well in accordance to the timer. Thus, the control box 24 may be configured to allow an operator to set the exact amount of fluid dispensed in a cycle by setting the amount of time the solenoid valves 48, 60 remain opened. Regarding the capping and/or corking station 34, the capping and/or corking station cylinders 46 may be activated in accordance with the manual switches 132, 134 which are connected to the contact relay 136. Thus, the capping and/or corking station cylinders 46 may be manually activated to perform a capping function when a switch is activated. The electrical system 100 may include an emergency stop switch 138, along with a 24 volt DC power supply 110. Other embodiments are contemplated with other electrical circuits configured to perform the functionality described herein.

Referring now to FIG. 5, a schematic view of a pneumatic system 80 of the bottle filler, capper and/or corker system 10 is shown. The lines connecting the various elements shown in FIG. 5 may represent conduits, tubes, pipes or the like configured to transfer fluid between the elements described herein. While these conduits, tubes and pipes are not shown in FIG. 1 so that the elements shown in FIG. 1 are more visible and not hidden by tubes or other fluid conduits, these tubes or conduits may be connected to the system in the manner described herein.

The pneumatic system 80 may include a compressed air inlet 26 for receiving compressed air from a compressed air tank, reservoir or other source (not shown). The compressed air source may be provide compressed air through a conduit connected to the compressed air inlet and shutoff 26 (also shown in FIG. 1) and may be regulated by the compressed air regulator 28. The compressed air may be provided to the station cylinders 46 (shown in FIG. 1). A hand control 52 may be provided for activating the capping and/or corking station cylinders 46. The hand control 52 may be operably connected to the electrical switches 132, 134 described herein above, and may be used to activate the capping and/or corking station cylinders 46 to perform a capping cycle and apply a cap to the bottles 42. The hand control 52 may be replaced by any device, valve or switch that is capable of opening and closing to allow air from the compressed air inlet 26 to enter the capping and/or corking station cylinders 46 to perform capping. The number of cylinders 46 shown is four, which is consistent with the embodiment shown in FIG. 1. However, other embodiments are contemplated which may include more or less capping cylinders to allow the capping and/or corking station 34 to cap more or less bottles in a given activation cycle.

The compressed air from the compressed air inlet 26 may further be provided to the filling station cylinder 16 (shown in FIG. 1). A toggle switch 50 may regulate when compressed air is provided to the filling station cylinder 16. The toggle switch 50 may be included in the control box 24 or located proximate the filling station cylinder 16. The toggle switch 50 may be operably connected to the cycle start switch 112 which may activate a fill cycle. Thus, when the cycle start switch 112 is activated from the control box 24, the toggle switch 50 may be activated to supply compressed air to the filling station cylinder 16. The filling station cylinder 16 may utilize this compressed air to move the assembly of the fill valves 14 downward and onto the bottles 40. Once the cycle is over, the filling station cylinder 16 may apply reverse pressure to pull up the assembly of the fill valves 14 from the bottles 40.

The compressed air from the compressed air inlet 26 may also be provided to the fill valve 14 described herein above and shown in FIGS. 2-3. A conduit or tube may connect the compressed air inlet 26 to a fill actuation solenoid valve 48. This fill actuation solenoid valve 48 may be electrically controlled by the solenoid 128 described herein above and shown in FIG. 4. The fill actuation solenoid valve 48 may then be connected to a fill valve 14 for supplying air to fulfill the functionality described herein above. A plurality of fill actuation solenoid valves 48 may be provided, one for each fill valve 14 included in the bottle filler, capper and/or corker system 10. In other embodiments, a single fill actuation solenoid valve 48 may be connected to the compressed air inlet 26. This single fill actuation solenoid valve 48 may be configured to open and close a plurality of fill valves 14 simultaneously.

As shown, a single compressed air inlet 26 may be provided for supplying compressed air to the capping and/or corking station cylinders 46, the filling station cylinder 16, and the fill valves 14. In other embodiments, each of the capping station 46, the filling station 16, and the assembly of the fill valves 14 may each include their own compressed air inlet 26 and dedicated compressed air lines, tubes, or conduits.

The pneumatic system 80 may include a carbon dioxide inlet 32 (also shown in FIG. 1) for receiving carbon dioxide from a carbon dioxide source such as a tank, reservoir or other source (not shown) which may be connected to the carbon dioxide inlet 32 through a line, pipe, tube, or conduit. The carbon dioxide inlet 32 may supply carbon dioxide to a fluid container 54 such as a keg, vat or other reservoir which may contain the fluid that is being used to fill the bottles 40. The carbon dioxide source may be provide carbon dioxide through a conduit connected to the carbon dioxide inlet and shutoff 32 (shown in FIG. 1) and may be regulated by the carbon dioxide regulator(s) 30 (shown in FIG. 1).

The carbon dioxide inlet 32 may further be connected to the fill valve 14. Carbon dioxide may be provided to the fill valve 14 in a manner regulated by a carbon dioxide purge valve 60 which may be a solenoid valve electrically connected to the purge solenoid 124 described hereinabove. A line, conduit, pipe or tube extending between the fill valve 14 and the carbon dioxide purge valve 60 may be configured to both supply carbon dioxide to the fill valve 14 prior to filling of the bottles 40 in a fill cycle, but also expel gas from the fill valve during filling of the bottles 40. Thus, this line may be a two way line which carries gas both to and from the fill valve 14. The carbon dioxide purge valve may be connected to a vent can 58 which may be configured to provide a vent pressure to the carbon dioxide purge valve 60 during venting in order to ensure that the bottles 40 remain pressurized during filling. This vent can 58 may regulate the pressure and vent air to the atmosphere, as shown by element 56.

Referring back to FIG. 1, the filler, capper and/or corker system 10 may include a frame 11 that includes wheels or another mobility mechanism. The frame 11 may be configured to retain the bottles at a convenient height for operators to interact with. The frame 11 may include a channel or lane 13 for receiving bottle totes 36 which may be configured to receive a group of bottles 40, 42, 44. The frame 11 may be expandable or retractable to allow for expansion or retraction of the filler, capper and/or corker system 10 by adding or subtracting fill valves 14 and/or capping cylinders 46.

The bottle totes 36 may be in-line frames for receiving a number of bottles that corresponds to the number of filling valves 14 in the filling station 12 and capping cylinders 46 in the capping and/or corking station 34. The bottle totes 36 may be included as components of the filler, capper and/or corker system 10, as the space between the bottles provided by the bottle totes 36 must dimensionally correspond to the space between the fill valves 14 and the capping and/or corking station cylinders 46. Other mechanical embodiments are contemplated than the totes 36 shown, but these embodiments each may hold and space the bottles 40, 42, 44 apart at the correct spacing for operation of the filler, capper and/or corker system 10. These bottle totes 36 may be configured to slide along the channel or lane 13 by an operator. In other embodiments, an automated movement system is contemplated for moving the bottle totes 36 along the lane 13.

Each of the filling station 12 and the capping and/or corking station 34 may include a tote stop 38 which may be moved into the channel to stop the bottle totes 36 in the correctly aligned position for filling and capping, respectively. Once stopped, additional devices or mechanisms may also be applied to hold the bottle totes 36 into place for filling and capping. For example, a first tote stop 38 may be provided for aligning the bottle tote 36 at the first location 201 at the filling station 12. A second tote stop 38 may be provided for aligning the bottle tote 36 at the second location 203 at the finishing station 34. Additional tote stops 38 may be provided at additional locations if necessary along the lane or channel 13.

Further included may be a vent manifold 20 and a fluid supply manifold 22 for receiving the compressed air lines, carbon dioxide lines, and fluid lines described hereinabove for supplying compressed air, carbon dioxide and fluid to the fill valve 14 as described hereinabove. While the embodiment shown in the Figures does not include these lines connected to the system 10, it should be understood that these lines may be connected in conformity with the schematics shown in FIGS. 4 and 5 and described hereinabove.

The filling station 12 may include a bracket 15 that holds a plurality of the fill valves 14. The fill valves 14 may be constructed such that they are top actuated by the filling station cylinder 16, as described hereinabove. The filling station cylinder 16 may be a pneumatic cylinder. The filling station 12, attached by the bracket 15, may ensure that each of the fill valves 14 is moved downward onto the bottles 40 simultaneously. Differently dimensioned brackets 15 may be provided with the filler, capper and/or corker system 10 for filling, capping and/or corking differently sized bottles. Thus, the filler, capper and/or corker system 10 may include a plurality of bracket sizes, which correspond to a plurality of bottle tote sizes that may be provided or sold incrementally as needed. Similarly, a bracket may be provided that holds the plurality of capping cylinders 46.

The control box 24 described herein may be configured to contain a user interface (not shown) and gauges and other displays for providing information to the operator. The control box 24 may further include various electrical components provided for in FIG. 4. Components from the control box 24 may be electrically connected through electrical wires to the appropriate components of the filling station 12, the capping and/or corking station 34 and the like, in a manner consistent with the schematics and descriptions provided hereinabove.

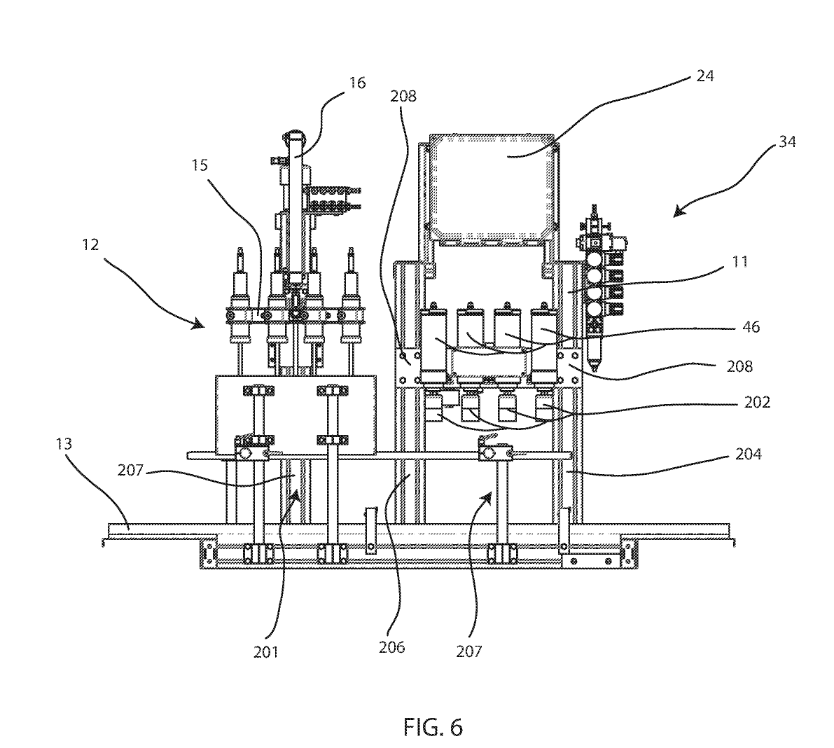

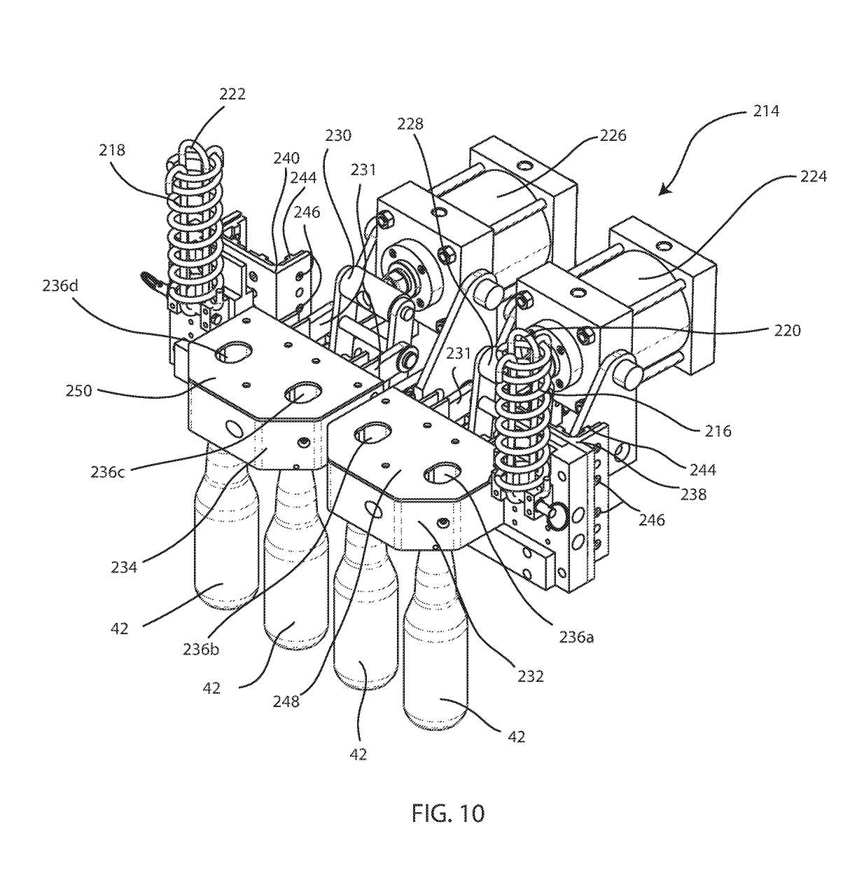

The heads from the capping and/or corking station 34 may be replaced to provide for corking of bottles in the event that a cork seal is desired. Corking may be accomplished in the same manner as capping with the cylinders 46 providing downward corking force for applying the cork to the top of the bottles 42. One particular embodiment contemplated for converting the filler, capper and/or corker system 10 to a corker is shown in FIGS. 6-13.

The filler, capper and/or corker system 10 may further be modular and expandable in design. Thus, more or less heads may be provided at the filling station 12 and the capping and/or corking station 34 than the embodiment shown. In other embodiments, a duplicate filling station 12, including four additional fill valves 14, may be provided immediately to the left or right of the filling station 12 shown in the embodiment in FIG. 1. Similarly, an additional or duplicate capping and/or corking station 34, having four additional capping cylinders 46, may be provided proximate the first capping and/or corking station 34 shown in the embodiment in FIG. 1. Similarly, an operator may simply buy an additional filler, capper and/or corker system 10 similar or the same as the embodiment depicted in FIG. 1 to double output. Moreover, the filler, capper and/or corker system 10 may be provided, in some embodiments, with a single fill valve 14 and a single capping cylinder 46. More valves 14 and cylinders 46 may be provided as space along the line allows.

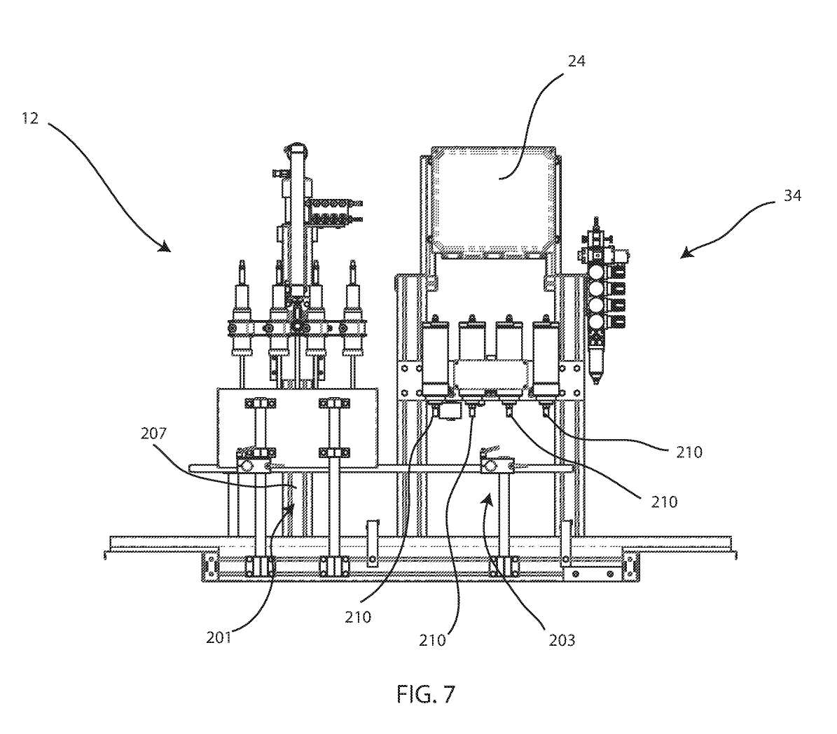

Referring now to FIG. 6, the bottle filler, capper and/or corker system 10 is shown having a plurality of crowing dies 202 located at the finishing station 34. The crowning dies 202 may be different than the crowning dies shown in FIG. 1. However, various dimensioned crowning dies 202 are contemplated to accommodate various dimensions, materials and/or types of caps for capping the bottles 42. The crowning dies 202 may include a female threaded portion (not shown) for attachment to plunging portions 210 shown in FIG. 7. The plunging portions 210 may each include a male threaded portion (not shown) for receiving the female threaded portion (not shown) of the crowning dies 202. The crowning dies 202 may be configured to crown and cap a bottle cap at the top of a bottle when pressed by the plunging portion 210. The plunging portion 210 may be operably connected to the capping and/or corking station cylinders 46. In the embodiment shown, one capping and/or corking station cylinder 46 is operably attached to one plunging portion 210. However, other embodiments are contemplated in which, for example, a single capping and/or corking station cylinder 46 may operate a plurality of plunging portions 210. In one embodiment, the capping and/or corking station cylinders 46 may pneumatically plunge or press the plunging portion 210 in a downward direction when activated. Other activation sources are contemplated such as pneumatic, magnetic or the like. This downward thrust or movement may be configured to press the plunging portion 210 and the crowning dies 202 onto each bottle. As described above, the bottles 42 may each already have an uncrowned cap placed thereon by a manual operator prior to the plunging of the plunging portion 210.

Each of the plurality of plunging portions 210 is shown having the attached crowning die 202 in FIG. 6 and with the crowning die 202 removed in FIG. 7. The removed crowning die 202 exposes the plunging portions 210, which may include threads or another attachment mechanism. FIG. 7 shows a first step in a conversion process in order to convert the bottle filler, capper and/or corker system 10 from being capable of capping to being capable of corking. This step includes removing the crowning dies 202 from the plunging portions 210.

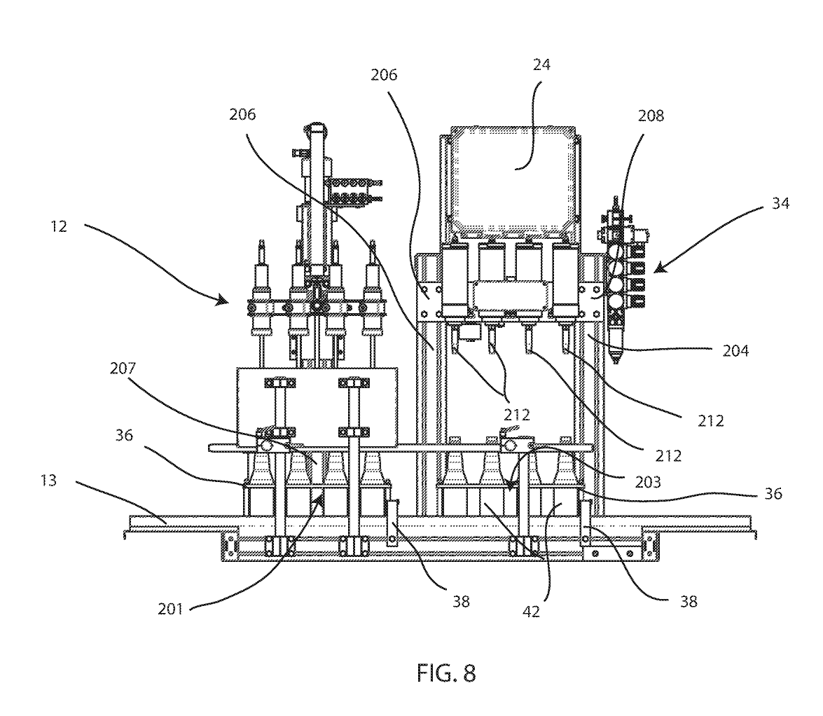

FIG. 8 shows another step in the conversion process. This step includes attaching cork pushing mechanisms 212 onto the plunging portions 210. These cork pushing mechanisms 212 may also be female threaded portions having a different shape and functionality than the crowning dies 202. The cork pushing mechanism may have a smaller diameter cross section than the crowning dies 202.

FIG. 8 further shows that the entirety of the finishing station 34 may be moved in a vertical direction along a first vertical post 204 and a second vertical post 206 with connection mechanisms 208 during the conversion from capping to corking. This may be required if a bottle to be corked has a different height or size than a bottle to be capped. Thus, the finishing station 34, including the capping and/or corking station cylinders 46, the CO2 regulators 30, the CO2 inlet shutoff 32, the compressed air inlet and shutoff 26, the compressed air regulator 28, and the control box 24 may be moved vertically along the vertical posts 204, 206 in order to accommodate bottles of different sizes. Similarly, the filling station 12 may be moved vertically upward and downward along a post 207, in the same manner depending on the desire to fill bottles of different sizes and heights. The post 207 may be part of the frame 11 and may be located at the first location 201.

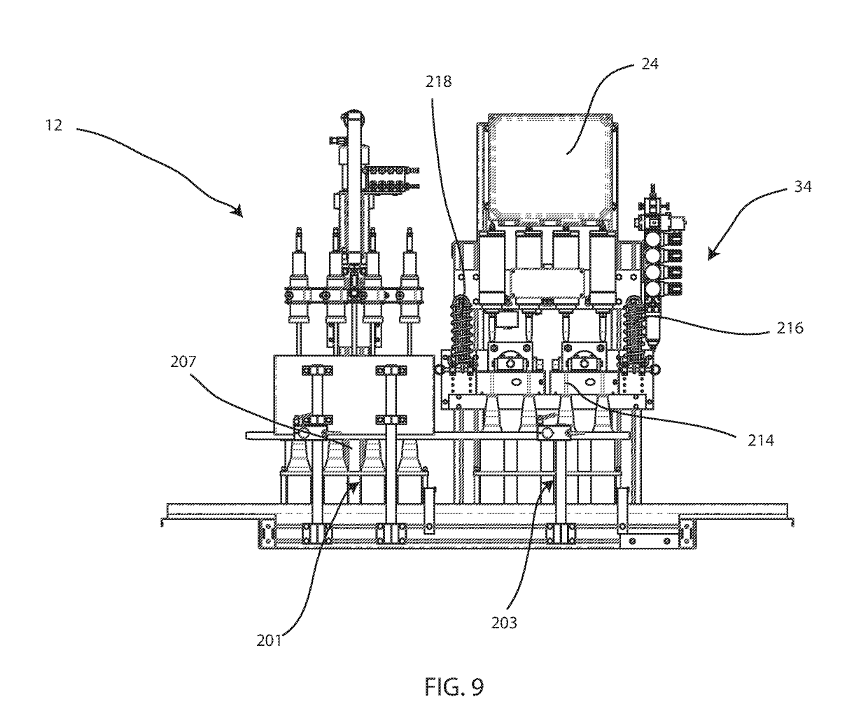

Referring to FIG. 9, a final step of the conversion process is shown where a corking mechanism 214 is attached to the frame 11 at the second location 203 at the finishing station 34. The corking mechanism 214 may be attached to each of the first and second vertical posts 204, 206. Further, the corking mechanism 214 may include springs 216, 218 which may attach to each of the corking mechanism 218 and the frame 11. The corking mechanism 214 may be slidably attached to the frame 11, and more particularly to the posts 204, 206 of the frame 11.

Slidable attachment of the corking mechanism 218 to the frame 11 may be accomplished and/or facilitated by two vertical sliding guides 238, 240: a first vertical sliding guide 238 attached to the right side of the corking mechanism and a second vertical sliding guide 240 attached to a left side of the corking mechanism 218. The vertical sliding guides 238, 240 may each include a plurality of removable protruding guide members 244 that correspond to channels found in the exterior of the vertical posts 204, 206. The removable protruding guide members 244 may each be attachable to the interior of the vertical sliding guides 238, 240 by screws 246. For example, the left and right protruding guide members 244 of each of the first and second vertical sliding guides 238, 240 may be removed prior to attaching the corking mechanism 218 to the vertical posts 204, 206. This may allow the first and second vertical sliding guides 238, 240 to be slid horizontally into position at the desired vertical location on the vertical posts 204, 206. Once in the desired location, the left and right protruding guide members 244 may each be slid vertically up or down along the vertical posts 204, 206 and into position within the first and second vertical sliding guides 238, 240 and attached via the screws 246.

In other embodiments, the corking mechanism 218 may not be slidably attached but instead may be attached in a stationary manner to the vertical posts 204, 206. Still further, a single vertical post 204, 206 may provide for attachment of the corking mechanism 218 to the frame 11. Other mechanisms for attachment of the corking mechanism 218 are contemplated, such as bolts, screws or the like.

Once the vertical sliding guides 238, 240 are secured to the vertical posts 204, 206, the corking mechanism 214 may slide freely along the vertical posts 204, 206 in the vertical direction. Next, springs 216 and 218, which may be attached to the corking mechanism 214, may be attached to the frame 11 using loops 220, 222. Once the springs 216, 218 are attached to each of the corking mechanism 214 and the frame 11, the corking mechanism 214 may hang suspended along the vertical posts 204, 206 by the springs 216, 218.

FIG. 9 shows the corking mechanism 214. The corking mechanism 214 includes a first housing portion 232, a second housing portion 234. The first housing portion 232 includes a first opening 236a and a second opening 236b exposed to a top surface 248 thereof. The second housing portion 234 includes a third opening 236b and a fourth opening 236d exposed to a top surface 250 thereof. The openings 236a, 236b, 236c, 236d may each be configured to receive a cork within a cavity defined by the openings 236a, 236b, 236c, 236d for compressing or collapsing the received cork prior to insertion and/or pressing of the cork into a top of a bottle. Each of the plurality of plunging portions 210 and/or the cork pushing mechanisms 212, may be configured to extend through, at least partially, each corresponding opening 236a, 236b, 236c, 236d when plunged, extended, pushed, or otherwise moved by the cylinders 46 of the finishing station 34. The openings 236a, 236b, 236c, 236d may be circular in shape. In other embodiments, the openings 236a, 236b, 236c, 236d may elongated and/or ovular in shape as shown. Other shapes are contemplated, such as square or rectangular.

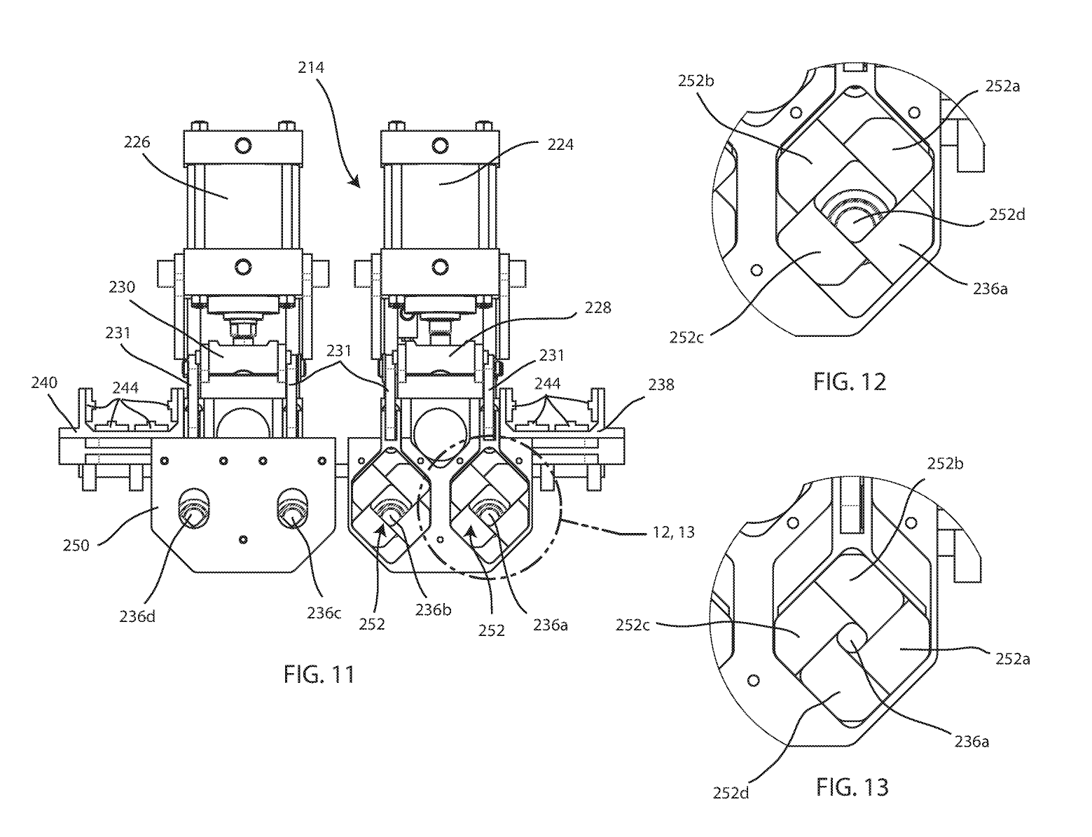

The corking mechanism 214 includes a first cylinder 224 and a second cylinder 226. The first and second cylinders 224, 226 may be pneumatic, hydraulic or the like. The first and second cylinders 224, 226 may be controlled by the control box 24 and the user interface that may be contained therein. Thus, the corking mechanism 214, in addition to being mechanically slidably attached to the frame 11, may further be electronically connected to the control box 24. The corking mechanism 214 may include more or less cylinders 224, 226 than the embodiment shown. In other embodiments, a single cylinder is contemplated, or a cylinder for each opening 236a, 236b, 236c, 236d. The first and second cylinders 224, 226 may be configured to press pivoting components 228, 230, respectively in order to actuate or trigger compression or collapsing of the openings 236a, 236b, 236c, 236d, as shown in FIGS. 11-13.

Referring now to FIGS. 11-13, the first and second housing portions 232, 234 may be configured to house two collapsing devices 252. Each collapsing device 252 may be configured to collapse one of the openings 236a, 236b, 236c, 236d. Each of the collapsing devices 252 may include a first collapsing device portion 252a, a second collapsing device portion 252b, a third collapsing device portion 252c, and a fourth collapsing device portion 252d. FIG. 11 shows that the upper surface 248 of the first housing portion 232 is removed to expose the collapsing devices 252 surrounding the first and second openings 236a, 236b. The third and fourth openings 236c, 236d may be likewise surrounded by similar or the same collapsing devices 252.

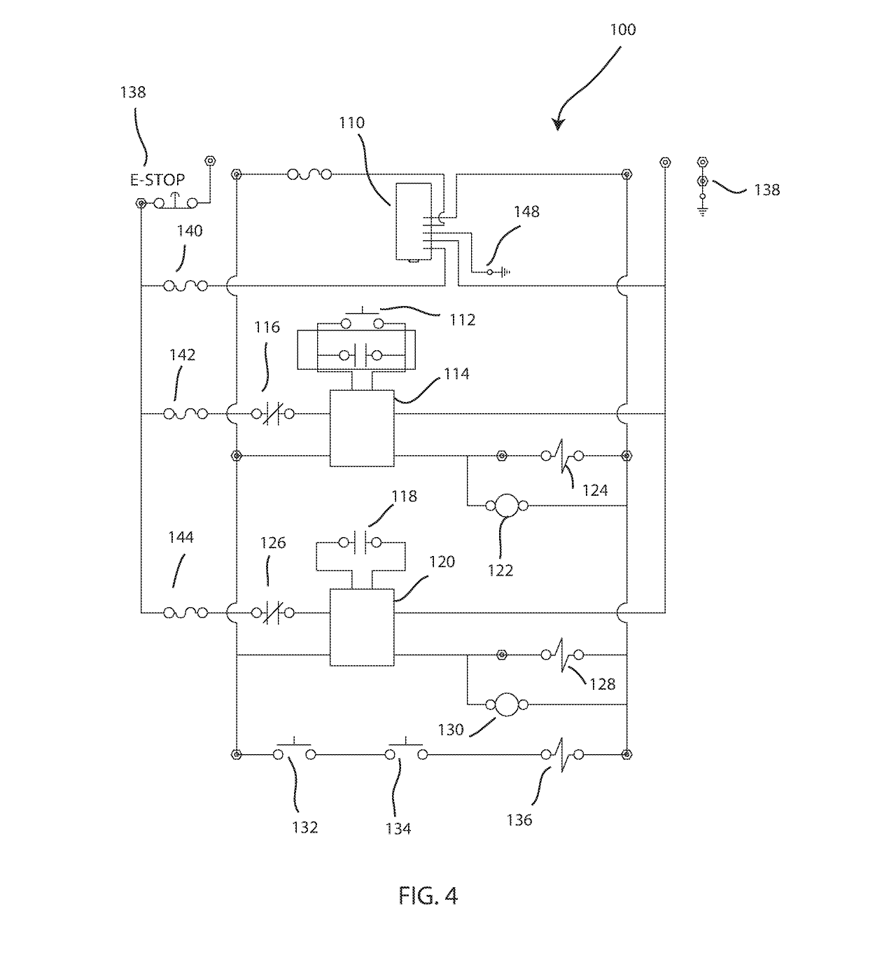

In operation, the first and second cylinders 224, 226 of the corking mechanism 214 may be triggered by an actuation from a user or operator, which may occur by the user or operator interacting with a user interface of the control box 24. The cylinders may then pivot or rotate the pivoting components 228, 230. Rotation of the pivoting components 228, 230 may trigger movement in arms 231 which causes collapsing of the first, second, third and fourth collapsing device portions 252a, 252b, 252c, 252d, as shown in FIG. 13. The corks located within each of the openings 236a, 236b, 236c, 236d may be thereby compressed or collapsed so that the corks are ready for insertion into a bottle top opening. This collapsing of the openings 236a, 236b, 236c, 236d may occur immediately prior to the plurality of plunging portions and/or cork pushing mechanisms 212 extend into the openings 236a, 236b, 236c, 236d to push the cork out of the corking mechanism 214 and into a bottle top opening. Other embodiments are contemplated in order to collapse the corks beyond the collapsing devices 252.

Once each of the corks have been collapsed within the openings 236a, 236b, 236c, 236d, the cork pushing mechanisms 212 may be plunged, pressed or otherwise pushed onto the corks in by extending the cork pushing mechanisms 212 a downward manner through the force from the cylinders 46. The cork pushing mechanisms 212 may be configured to be inserted into openings 236a, 236b, 236c, 236d to push the cork out of the bottom of the first and second housing portions 232, 234 and into the openings in the tops of the bottles 42. During the pushing by the cork pushing mechanisms 212, the entirety of the corking mechanism 214 may be moved vertically downward along the vertical posts 204, 206 toward the lane 13. In one embodiment, the plurality of bottles 42 may act as a stop to prevent the corking mechanism 214 from being moved vertically downward past a point where the corking mechanism 214 contacts the bottles 42. Once the corking is complete, the cork pushing mechanisms 212 may be retracted upward again, and the springs 216, 218 may be configured to move the corking mechanism 214 away from the lane 13 and the bottles 42. This may provide the clearance necessary to move the bottle tote 36 being corked into its completed station along the lane 13.

The corking mechanism 214 may include other means or mechanisms for suspension and return in addition to or replacing the springs 216, 218. For example, a single spring embodiment is contemplated. No springs may be necessary in an embodiment where the corking mechanism 214 is not configured to move or slide relative to the frame 11. Further, the springs 216, 218 may have various spring coefficients to provide for various speeds of return and resistance to being pushed. The springs 216, 218 may be metallic, or may be made of other appropriate materials to achieve the desired spring constant.

In another embodiment, a method of filling, capping and corking bottles is contemplated. The method may include first providing a bottle filler, capper and corker system, such as the filler, capper and/or corker system 10. The filler capper and corker system may include a frame, such as the frame 11, including a lane, such as the lane 13. The filler capper and corker system may include a filling station, such as the filling station 12, located above a first location, such as the first location 201 along the lane, the filling station including a plurality of valves, such as the plurality of fill valves 14. The filler capper and corker system may further include a finishing station, such as the finishing station 34, located above a second location along the lane, such as the second location 203. The finishing station including at least one pneumatic cylinder, such as the cylinder 46, the at least one pneumatic cylinder configured to plunge a plurality of plunging portions, such as the plunging portions 210 and/or the cork pushing mechanisms 212.

The method may include filling, by the filling station through the plurality of valves, a first plurality of bottles, such as the bottles 42. The method may include receiving, by each of the plurality of plunging portions, a separate crowning die, such as the crowning die 202. The method may include plunging, with the at least one pneumatic cylinder, the plurality of plunging portions, and capping the first plurality of bottles with each of the separate crowing die. The method may include removing the separate crowing die from each of the plurality of plunging portions and filling, by the filling station through the plurality of valves, a second plurality of bottles, such as the bottles 40. The method may include attaching a corking mechanism, such as the corking mechanism 214, to the frame above the second location along the lane, the corking mechanism including a plurality of openings, such as the plurality of openings 236a, 236b, 236c, 236d, and a collapsing device located in each of the plurality of openings, such as the collapsing devices 252.

The method may include receiving, in each of the plurality of openings, a separate cork. The method may include collapsing, with the collapsing device, each of the separate corks, and plunging, with the at least one pneumatic cylinder, each of the plurality of plunging portions through one of the plurality of openings. The method may include pushing, with each of the plurality of plunging portions, each of the separate corks into top openings in the second plurality of bottles.

Still further, the method may include slidably attaching the corking mechanism to the frame; and vertically moving the corking mechanism downward toward the lane, by the plurality of plunging portions, during the plunging. The method may include providing a spring, such as the spring 216, 218, attached to the corking mechanism and the frame, and moving, with the spring, the corking mechanism away from the lane after corking.

Moreover, the method may include providing a pneumatic cylinder system in the corking mechanism, such as the pneumatic cylinders 224, 226. The method may include accomplishing the collapsing, with the collapsing device, by the pneumatic cylinder system.

The method may further include the frame including a first vertical post and a second vertical post, such as the first and second vertical posts 204, 206. The corking mechanism may include a first vertical sliding guide and a second vertical sliding guide, such as the first and second vertical sliding guides 238, 240. The slidably attaching the corking mechanism to the frame may further include attaching the first vertical sliding guide to the first vertical post and the second vertical sliding guide to the second vertical post.

The method may still further include providing a first tote stop in the lane and a second tote stop in the lane, such as the first and second tote stops 38. The method may include aligning the first plurality of bottles with the first tote stop at the first location below the filling station, and aligning the first plurality of bottles with the second tote stop at the second location below the finishing station. The method may include providing a first tote and a second tote, such as the bottle totes 36. The first tote and the second tote may include openings for a number of bottles equal to the number of the plurality of fill valves in the filling station and further equal to the number of the plurality of plunging portions in the finishing station.

Moreover, the method may include providing a control box, such as the control box 24, in the bottle filler, capper and corker system including a processor and an operator interface. The method may include controlling, with the control box, the filling station and the finishing station.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A bottle filler, capper and corker system comprising:
a frame including a lane configured to receive a bottle tote holding a plurality of bottles;
a filling station located above a first location along the lane, the filling station including a plurality of fill valves configured to simultaneously fill the plurality of bottles;
a finishing station located above a second location along the lane, the finishing station including at least one cylinder, the at least one cylinder configured to plunge a plurality of plunging portions, each of the plurality of plunging portions configured to removably receive a crowing die; and
a corking mechanism removably attachable to the frame at the finishing station, the corking mechanism including a plurality of openings each configured to receive a cork, each of the plurality of plunging portions extending through one of the plurality of openings when plunged by the at least one cylinder.

2. The bottle filler, capper and corker system of claim 1, wherein the corking mechanism is slideably attached to the frame, wherein the corking mechanism is configured to be moved vertically downward toward the lane during corking by the plurality of plunging portions.

3. The bottle filler, capper and corker system of claim 2, further comprising a spring attached to the corking mechanism and the frame, the spring configured to move the corking mechanism away from the lane after corking.

4. The bottle filler, capper and corker system of claim 3, wherein contact with the plurality of bottles acts as a stop to prevent the corking mechanism from being moved vertically downward during corking.

5. The bottle filler, capper and corker system of claim 1, wherein the corking mechanism includes a cylinder system configured to collapse each of the plurality of openings prior to the plurality of plunging portions extending through the openings when plunged.

6. The bottle filler, capper and corker system of claim 2, wherein the frame includes a first vertical post and a second vertical post, and wherein the corking mechanism includes a first vertical sliding guide and a second vertical sliding guide, the first vertical sliding guide slidably attachable to the first vertical post, the second vertical sliding guide slidably attachable to the second vertical post.

7. The bottle filler, capper and corker system of claim 1, further comprising a plurality of crowing dies, each threadably attachable to one of the plurality of plunging portions, wherein each of the plurality of crowning dies is threaded and wherein each of the plurality of plunging portions is threaded.

8. The bottle filler, capper and corker system of claim 1, wherein the cylinder system includes a first cylinder and a second cylinder, wherein the plurality of openings includes four openings, and wherein the plurality of plunging portions include four plunging portions.

9. The bottle filler, capper and corker system of claim 1, further comprising a first tote stop in the lane and a second tote stop in the lane, wherein the first tote stop is configured to align a first tote at the first location below the filling station, and wherein the second tote stop is configured to align a second tote at the second location below the finishing station.

10. The bottle filler, capper and corker system of claim 9, further comprising the first tote and the second tote, wherein the first tote and the second tote include openings for a number of bottles equal to the number of the plurality of fill valves in the filling station and further equal to the number of the plurality of plunging portions in the finishing station.

11. The bottle filler, capper and corker system of claim 1, further comprising a control box including a processor and an operator interface, wherein the filling station and the finishing station are controlled by the control box.

12. A method of filling, capping and corking bottles comprising:
providing a bottle filler, capper and corker system including:
a frame including a lane;
a filling station located above a first location along the lane, the filling station including a plurality of valves;
a finishing station located above a second location along the lane, the finishing station including at least one cylinder, the at least one cylinder configured to plunge a plurality of plunging portions; and
filling, by the filling station through the plurality of valves, a first plurality of bottles;
receiving, by each of the plurality of plunging portions, a separate crowning die;
plunging, with the at least one cylinder, the plurality of plunging portions;
capping the first plurality of bottles with each of the separate crowing die;
removing the separate crowing die from each of the plurality of plunging portions;
filling, by the filling station through the plurality of valves, a second plurality of bottles;
attaching a corking mechanism to the frame above the second location along the lane, the corking mechanism including a plurality of openings and a collapsing device located in each of the plurality of openings;
receiving, in each of the plurality of openings, a separate cork;
collapsing, with the collapsing device, each of the separate corks;
plunging, with the at least one cylinder, each of the plurality of plunging portions through one of the plurality of openings; and
pushing, with each of the plurality of plunging portions, each of the separate corks into top openings in the second plurality of bottles.

13. The method of claim 12, further comprising:
slidably attaching the corking mechanism to the frame; and
vertically moving the corking mechanism downward toward the lane, by the plurality of plunging portions, during the plunging.

14. The method of claim 13, further comprising
providing a spring attached to the corking mechanism and the frame; and
moving, with the spring, the corking mechanism away from the lane after corking.

15. The method of claim 12, further comprising:
providing a cylinder system in the corking mechanism; and
wherein the collapsing, with the collapsing device, each of the separate corks is accomplished by the cylinder system.

16. The method of claim 13, wherein the frame includes a first vertical post and a second vertical post, and wherein the corking mechanism includes a first vertical sliding guide and a second vertical sliding guide, and wherein slidably attaching the corking mechanism to the frame includes attaching the first vertical sliding guide to the first vertical post and the second vertical sliding guide to the second vertical post.

17. The method claim 12, further comprising:
providing a first tote stop in the lane and a second tote stop in the lane;
aligning the first plurality of bottles with the first tote stop at the first location below the filling station; and
aligning the first plurality of bottles with the second tote stop at the second location below the finishing station.

18. The method of claim 17, further comprising providing a first tote and a second tote, wherein the first tote and the second tote include openings for a number of bottles equal to the number of the plurality of fill valves in the filling station and further equal to the number of the plurality of plunging portions in the finishing station.

19. The method of claim 12, further comprising:
providing a control box in the bottle filler, capper and corker system including a processor and an operator interface; and
controlling, with the control box, the filling station and the finishing station.

20. A corking mechanism comprising:
a first vertical sliding guide slidably attachable to a first vertical post;
a second vertical sliding guide slidably attachable to a second vertical post;
a plurality of openings each configured to receive a cork;
a collapsing device located in each of the plurality of openings;
a spring; and
a cylinder system in the corking mechanism, wherein the cylinder system is configured to collapse each of the collapsing devices located in each of the plurality of openings.
